(19) United States
(12) Patent Application Publication
(10) Pub. No.: US 2024/0133131 A1
(43) Pub. Date: Apr. 25, 2024

(54) HYDRAULIC PAVER SYSTEM, A METHOD, AND A CONTROL UNIT FOR OPERATING AN ELECTRIC PAVER IN DIFFERENT OPERATION MODES, AN ELECTRIC PAVER FOR CONSTRUCTING A ROAD SURFACE, A COMPUTER PROGRAM, AND A COMPUTER READABLE MEDIUM

(71) Applicant: VOLVO CONSTRUCTION EQUIPMENT AB, Eskilstuna (SE)

(72) Inventors: Sanal Raj Kollanandi, Hameln (DE); Philipp Eschert, Hameln (DE)

(21) Appl. No.: 18/368,723

(22) Filed: Sep. 14, 2023

(30) Foreign Application Priority Data
Oct. 20, 2022 (EP) 22203039.7

(51) Int. Cl. E01C 19/48; F15B 15/18

(52) U.S. Cl. CPC E01C 19/4853; F15B 15/18; E01C 2301/14

(57) ABSTRACT

A hydraulic paver system for operating an electric paver in different operation modes including a first hydraulic circuit and a second hydraulic circuit, wherein the first hydraulic circuit includes a first hydraulic pump arrangement configured for providing a hydraulic driving power to driving device(s) for driving the electric paver, and the second hydraulic circuit includes a second hydraulic pump arrangement configured for providing hydraulic working power for working device(s) of the electric paver for paving, wherein the second hydraulic pump arrangement is driven in the paving mode for providing the hydraulic working power, and a control unit for operating the electric paver in the different operation modes, wherein in the transporting mode the first hydraulic circuit is activated and the second hydraulic circuit is deactivated, wherein the deactivated second hydraulic circuit provides a hydraulic standby power that is smaller than the hydraulic working power provided in the paving mode.

### CROSS REFERENCE TO RELATED APPLICATIONS

This application claims priority to European Patent Application No. 22203039.7, filed on 21 Oct. 2022, the disclosure and content of which is incorporated by reference herein in its entirety.

### TECHNICAL FIELD

The present disclosure relates to a hydraulic paver system for operating an electric paver in different operation modes. Further, the present disclosure relates to an electric paver for constructing a road surface. Further, the present disclosure relates to a method for operating an electric paver in different operation modes. Finally, the present disclosure relates to a computer program and a computer readable medium.

### BACKGROUND

From U.S. Pat. No. 8,356,958 B2 a paver is known that comprises a primary driving aggregate with a combustion engine, particularly a diesel engine, and functional units with hydraulic pumps, which are driven from a crankshaft of the combustion engine. DE 2 112 327 A1 relates to a paver with a hydraulic drive for a drive axle comprising an adjustable pump and hydraulic drives for working devices, such as conveyors, material distributors, screeds, vibrators and alike.

For different operation modes of pavers, it is known to provide different operation speeds of hydraulic pumps of a hydraulic paver system. This is usually realized by an internal combustion engine in combination with a transfer gearbox. However, the output speeds of the gearbox are permanently dependent on the input speed provided at the gear box from the internal combustion engine. This results in hydraulic losses in the hydraulic paver system, as each pump of the hydraulic system of the paver runs at the set speed requested by the highest consumer function of the hydraulic paver system. Thus, improvements of hydraulic paver systems are needed.

### SUMMARY

An object of the present disclosure is to provide a hydraulic paver system, an electric paver, a method, a control unit, a computer program, and a computer readable medium to overcome the disadvantages outlined above. In particular, an object of the present disclosure is to provide a hydraulic paver system, an electric paver, a method, a control unit, a computer program, and a computer readable medium that provides an increased efficiency when operating a paver to construct road surfaces.

According to a first aspect of the present disclosure, the object is achieved by a hydraulic paver system according to claim 1.

The hydraulic paver system is configured for operating an electric paver in different operation modes. The operation modes are at least a transporting mode and a paving mode that is different to the transporting mode.

In the transporting mode the hydraulic paver system and, thus, the electric paver is operated without conducting paving operations. Such paving operations typically comprise but are not limited to operating the hopper, conveying paving material required for constructing the road surface along the direction of travel of the electric paver, distributing the paving material perpendicular to the direction of travel or operating the screed device of the electric paver. In the transporting mode, the hydraulic paver system is configured to be operated to drive the electric paver from a first position to a second position without paving, i.e., without conducting paving operations. For example, the hydraulic paver system may operate the electric paver in the transporting mode to unload the electric paver from a truck and to drive the electric paver to the place of the construction site where the road surface construction is to start. In another example, the hydraulic paver system may operate in the transporting mode in order to drive the electric paver to and on the truck after having finished the road surface construction. Finally, in a further example, the hydraulic paver system may operate in the transporting mode to drive the electric paver to a parking position or to drive the electric paver from a parking position to the place of the construction site where the road surface construction is to start. In all of these examples, the paver is driven between different locations without conducting paving operations.

In the paving mode, the electric paver is driven by means of the hydraulic paver system from a first position to a second position whilst paving. Thus, operating the hydraulic paver system in the paving mode means that the electric paver is conducting paving operations whilst being driven between the first position and the second position. In the paving mode, a road surface is constructed by conducting the paving operations whilst driving the electric paver between the first position and the second position.

To operate the electric paver in these different operation modes, the hydraulic paver system comprises a first hydraulic circuit and a second hydraulic circuit, which can be controlled independently of each other. In particular, the first hydraulic circuit can be controlled separate from the second hydraulic circuit. Mainly, the first hydraulic circuit is provided as drive system for driving the paver between two positions and the second hydraulic circuit is provided as drive system for actuating the paving operations.

Operating the hydraulic paver system and, thus, the electric paver in these different operation modes enables to reduce hydraulic losses and, in turn, enables to increase efficiency of the hydraulic paver system and, thus, the electric paver. This is realized as will be described in the following.

The first hydraulic circuit comprises a first hydraulic pump arrangement that is configured for providing a hydraulic driving power to at least one driving device for driving the electric paver. For example, the at least one driving device is some kind of hydraulic motor. For example, the first hydraulic pump arrangement may comprise at least one fixed displacement pump and/or at least one variable displacement pump and/or at least one screw pump and/or alike.

The first hydraulic pump arrangement is coupled to a first electric motor unit, which drives the first hydraulic pump arrangement in a transporting mode and/or in a paving mode for providing the hydraulic driving power. In some embodiments, the first hydraulic pump arrangement is coupled to the first electric motor unit in a material-locking and/or form-fitting and/or force-fitting manner. In particular, by coupling the first hydraulic pump arrangement to the first electric motor unit, the speed of the first hydraulic pump arrangement is proportional to the speed of the first electric motor unit. In some embodiments, a gearbox between the first electric motor unit and the first hydraulic pump arrangement is not provided. In this case, the speed of the first hydraulic pump arrangement corresponds to the speed of the first electric motor unit. It may alternatively be preferred that a gearbox between the first electric motor unit and the first hydraulic pump arrangement is provided.

The first electric motor unit may be a synchronous or asynchronous motor.

The second hydraulic circuit comprises a second hydraulic pump arrangement that is configured for providing hydraulic working power for at least one working device of the electric paver for paving. For example, the at least one working device is some kind of actuation device, for example an auger device and/or a cylinder device and/or a conveyor device and/or alike. For example, the second hydraulic pump arrangement may comprise at least one fixed displacement pump and/or at least one variable displacement pump and/or at least one screw pump and/or alike.

The second hydraulic pump arrangement is coupled to a second electric motor unit, which drives the second hydraulic pump arrangement in the paving mode for providing the hydraulic working power. In some embodiments, the second hydraulic pump arrangement is coupled to the second electric motor unit in a material-locking and/or form-fitting and/or force-fitting manner. In particular, by coupling the second hydraulic pump arrangement to the second electric motor unit, the speed of the second hydraulic pump arrangement is proportional to the speed of the second electric motor unit. In some embodiments, a gearbox between the second electric motor unit and the second hydraulic pump arrangement is not provided. In this case, the speed of the second hydraulic pump arrangement corresponds to the speed of the second electric motor unit. It may alternatively be preferred that a gearbox between the second electric motor unit and the second hydraulic pump arrangement is provided.

The second electric motor unit may be a synchronous or asynchronous motor.

Further, the hydraulic paver system comprises a control unit that is signalling coupled with the first hydraulic circuit and the second hydraulic circuit. In some embodiments, the control unit is or comprises a microprocessor with a memory and signalling inputs and signalling outputs. In particular, the control unit may be a personal computer or may be provided remote on a server.

The control unit is configured for operating the electric paver in the different operation modes depending on an operation mode selection input. The operation mode selection input may be provided by the user. For example, the user may select a desired operation mode via a touch screen or a button or alike, which may represent the operation mode selection input. Depending on the operation mode selection input, the control unit is configured to activate and/or deactivate the first hydraulic circuit and/or activate and/or deactivate the second hydraulic circuit. In particular, the control unit is configured to automatically activate and/or automatically deactivate the first hydraulic circuit and/or automatically activate and/or automatically deactivate the second hydraulic circuit depending on the operation mode selection input. In some embodiments, the control unit is configured to activate and/or deactivate the first hydraulic circuit and/or activate and/or deactivate the second hydraulic circuit by default depending on the operation mode selection input.

In the transporting mode the first hydraulic circuit is activated and the second hydraulic circuit is deactivated. In some embodiments, independent on whether the hydraulic paver system and, thus, the electric paver is operated in transporting mode or paving mode, the first hydraulic circuit is activated automatically by default for driving the electric paver from a first position to a second position. In particular, the activated first hydraulic circuit is equivalent to a first hydraulic circuit that is turned on. In some embodiments, if the first hydraulic circuit is activated, the first hydraulic pump arrangement is driven by the first electric motor unit. In particular, if the first hydraulic circuit is activated, the first electric motor unit is turned on and running with a speed and, accordingly, the first hydraulic pump arrangement is turned on and running depending on the first electric motor unit.

It is to be understood that if the hydraulic paver circuit is operated in the transporting mode, the second hydraulic circuit is deactivated, in particular turned off, by default. However, the second hydraulic circuit may be activated manually in the transporting mode. For example, the second hydraulic circuit may be switched on manually by the user of the electric paver in the transporting mode. In some embodiments, in the transporting mode, the second electric motor unit and/or the second hydraulic pump arrangement is deactivated. It is to be understood that in the transporting mode, the second electric motor unit may be switched to a second electric generator unit and functions as a generator. In particular, in the transporting mode, when the second hydraulic circuit is deactivated, the second electric motor unit may function as an electric generator unit. If the second electric motor unit is switched to a second electric generator unit, the second electric motor unit does not provide any hydraulic power for the working devices. Rather, the working devices provide hydraulic power, which is transferred in the second electric generator unit into electricity.

In the transporting mode, the deactivated second hydraulic circuit provides a hydraulic standby power that is smaller than the hydraulic working power provided in the paving mode by the second hydraulic circuit. Notably, the hydraulic standby power may be zero. It is to be understood that if the second hydraulic circuit provides a standby power of zero, the deactivated second hydraulic circuit is equivalent to a second hydraulic circuit that is turned off. In particular, in the transporting mode, where the second electric motor unit functions as a second electro generator unit, the second electric motor unit does not provide any power for driving the working devices but consumes and, thus, transfers hydraulic power into electric power. Thus, in that regard, the standby power is understood to be negative when the second electric motor unit functions as the second electro generator unit, which is driven by the working devices.

By providing the first hydraulic pump arrangement in the first hydraulic circuit and by providing the second hydraulic pump arrangement in the second hydraulic circuit, a higher range of workings speeds is enabled independent on the different working scenarios. In particular, providing this first hydraulic circuit and this second hydraulic circuit allows to activate and/or deactivate the respective first and/or second electro motor unit and, thus, the respective hydraulic pump arrangements, which leads to reduced losses due to circulation of hydraulic fluid in the first and second hydraulic circuit.

Further, as the functions are divided up into the first and second hydraulic circuit, the speed of the first and second electro motor unit and, thus, of the first and second hydraulic pump arrangement may be controlled independent from each other, which further reduces hydraulic losses.

According to an embodiment of the hydraulic paver system it is provided that in the paving mode the first hydraulic circuit is activated and the second hydraulic circuit is activated. In some embodiments, the second hydraulic circuit is turned on automatically by default if the hydraulic paver system and, thus, the electric paver is operated in paving mode. Additionally or alternatively, in the transport mode, it is provided that the second hydraulic circuit is turned off, in particular turned off automatically by default, and/or the second hydraulic circuit may be turned on manually by a user.

This embodiment allows to deactivate, in particular turn off, any hydraulic circuits that are not needed. Deactivating or turning off the respective hydraulic circuits that comprise working devices that are not needed for a certain operation mode allows to reduce or stop hydraulic losses at the respective hydraulic pump arrangement

Further to an embodiment of the hydraulic paver system it is provided that in the activated first hydraulic circuit the first electric motor unit is driving the first hydraulic pump arrangement, and/or in the deactivated first hydraulic circuit the first electric motor unit is not driving the first hydraulic pump arrangement, wherein the deactivated first hydraulic circuit the first electric motor unit is deactivated, and/or in the activated second hydraulic circuit the second electric motor unit is driving the second hydraulic pump arrangement, and/or in the deactivated second hydraulic circuit the second electric motor unit is not driving the second hydraulic pump arrangement, wherein the deactivated second hydraulic circuit the second electric motor unit is deactivated.

In another embodiment of the hydraulic paver system, the first hydraulic circuit comprises at least one driving circuit (e.g., two driving circuits), wherein the at least one driving circuit comprises at least one pump (e.g., at least two pumps), in particular at least one variable displacement pump and/or at least one fixed displacement pump, wherein the first hydraulic pump arrangement comprises the at least one pump of the at least one driving circuit.

According to another embodiment of the hydraulic paver system, the at least one driving circuit comprises at least two pumps, in particular the variable displacement pump and the fixed displacement pump, which are connected in parallel. Additionally or alternatively, the at least one driving circuit comprise two variable displacement pumps, which are connected in parallel.

In yet a further embodiment of the hydraulic paver system, the first hydraulic circuit comprises at least one tamper circuit and/or at least one cooling circuit, wherein the at least one tamper circuit comprises a pump (e.g., a fixed displacement pump) that is part of the first hydraulic pump arrangement, wherein the pump of the at least one tamper circuit is configured for providing a hydraulic tamping power to a tamping device for tamping with the electric paver, and/or the at least one cooling circuit comprises a pump (e.g., a fixed displacement pump) that is part of the first hydraulic pump arrangement, wherein the pump of the at least one cooling circuit is configured for providing a hydraulic flow to a cooling device for cooling the hydraulic fluid of the first hydraulic circuit, wherein the at least one tamper circuit and the at least one cooling circuit may be the same circuit.

In particular, by this embodiment it is ensured that sufficient flow for the cooling circuit is ensured, even though the second hydraulic pump arrangement is deactivated.

Further, according to another embodiment of the hydraulic paver system, the pump or the pumps of the first hydraulic pump arrangement are coupled to the first electric motor unit, wherein the pumps of the first hydraulic pump arrangement that are coupled to the first electric motor unit may be connected in parallel.

According to a further embodiment of the hydraulic paver system the working devices comprise at least one hydraulic conveyor actuation device for driving at least one conveyor device for conveying paving material along the direction of travel of the electric paver, wherein the paving material is conveyed in or against the direction of travel, and/or at least one hydraulic auger actuation device for driving at least one auger device for distributing the paving material crosswise to the direction of travel of the electric paver, and/or at least one hydraulic cylinder actuation device for lifting and/or extending a screed device of the electric paver and/or for opening a hopper and/or for closing the hopper, and/or at least one hydraulic tamper actuation device for driving at least one tamper device of the electric paver.

Additionally or alternatively, the second hydraulic circuit comprises at least one hydraulic working circuit, wherein the at least one hydraulic working circuit comprises at least one pump, and/or wherein the at least one hydraulic working circuit is at least one of the following:
at least one conveyor circuit that is configured for providing hydraulic conveyor power for the at least one hydraulic conveyor actuation device for driving the at least one conveyor device of the electric paver,
at least one auger circuit that is configured for providing hydraulic auger power for the at least one hydraulic auger actuation device for driving the at least one auger device of the electric paver,
at least one cylinder circuit that is configured for providing hydraulic cylinder power for the at least one hydraulic cylinder actuation device for lifting and/or extending the screed device of the electric paver and/or for closing the hopper and/or for opening the hopper, and
at least one tamper circuit that is configured for providing hydraulic tamper power for the at least one hydraulic tamper actuation device for driving the tamper device of the electric paver,
at least one vibration circuit that is configured for providing hydraulic vibration power for the at least one hydraulic vibration actuation device for driving the vibration device of the electric paver
wherein the at least one auger circuit and the at least one conveyor circuit are the same hydraulic circuit.

According to yet another embodiment of the hydraulic paver system, it is provided that the at least one cylinder circuit comprises a pump (e.g., a variable displacement pump) and/or the at least one conveyor circuit comprises a pump (e.g., a variable displacement pump), the at least one auger circuit comprises a pump (e.g., a variable displacement pump), wherein in the case the at least one auger circuit and the at least one conveyor circuit are the same hydraulic circuit, the pumps of the at least one conveyor circuit and the at least one auger circuit are connected in parallel.

Further, according to an embodiment of the hydraulic paver system, the pump of the at least one cylinder circuit and/or the pump of the at least one auger circuit and/or the pump of the at least one conveyor circuit and/or the pump of the at least one tamper circuit are coupled to the second electric motor unit, wherein the pumps of the at least one cylinder circuit and/or of the at least one auger circuit and/or the at least one conveyor circuit and/or the pump of the at least one tamper circuit are connected in parallel.

Yet according to a further embodiment of the hydraulic paver system it is provided that the first hydraulic circuit comprises at least one hydraulic driving device (e.g., two hydraulic driving devices), wherein each hydraulic driving device is fluidically connected on their input side to the at least one pump of the at least one driving circuit, so that the pump of the respective at least one driving circuit delivers a hydraulic fluid in the direction of the hydraulic driving device during operation of the electric paver, wherein the output side of each hydraulic driving device is fluidically connected to the input side of the at least one pump of the at least one driving circuit and/or a tank unit.

According to a further embodiment of the hydraulic paver system, the first hydraulic circuit comprises the hydraulic tamper actuation device, wherein the hydraulic tamper actuation device is fluidically connected on its input side to the pump of the respective at least one tamper circuit, so that the pump of the respective at least one tamper circuit delivers a hydraulic fluid in the direction of the hydraulic tamper actuation device during operation of the paver, wherein the output side of each hydraulic tamper actuation device is fluidically connected to the tank unit, wherein a share of the hydraulic fluid is forwarded to the tank through the cooling device and/or through a filtering device.

This embodiment has the particular advantage that no additional pump for circulating the hydraulic fluid within the respective hydraulic circuit is needed for cooling purposes.

Further, according to an embodiment of the hydraulic paver system, the second hydraulic circuit comprises the hydraulic cylinder actuation device, wherein the hydraulic cylinder actuation device is fluidically connected on its input side to the pump of the respective at least one cylinder circuit, so that the pump delivers a hydraulic fluid in the direction of the hydraulic cylinder actuation device during operation, wherein the output side of each hydraulic cylinder actuation device is fluidically connected to the tank unit, and/or the second hydraulic circuit comprises the hydraulic auger actuation device, wherein the hydraulic auger actuation device is fluidically connected on its input side to the pump of the respective at least one auger circuit, so that the pump delivers a hydraulic fluid in the direction of the hydraulic auger actuation device during operation, wherein the output side of each hydraulic auger actuation device is fluidically connected to the tank unit, wherein a share of the hydraulic fluid is forwarded to the tank unit through the cooling device and/or through the filtering device, and/or the second hydraulic circuit comprises the hydraulic conveyor actuation device, wherein the hydraulic conveyor actuation device is fluidically connected on its input side to the pump of the respective at least one conveyor circuit, so that the pump delivers a hydraulic fluid in the direction of the hydraulic conveyor actuation device during operation, wherein the output side of each hydraulic conveyor actuation device is fluidically connected to the tank unit, wherein a share of the hydraulic fluid is forwarded to the tank unit through the cooling device and/or through the filtering device,

According to a further aspect of the present disclosure, the object is achieved by an electric paver according to claim 14. The electric paver is configured for constructing a road surface. The electric paver comprises a hydraulic paver system according to the aspect and embodiments described herein.

As to the advantages, embodiments and details of the electric paver, reference is made to the corresponding aspect and embodiments of the hydraulic paver system described herein above.

According to a further aspect of the present disclosure, the object is achieved by method according to claim 15. The method is for operating a hydraulic paver system and, thus, an electric paver in different operation modes according to the aspect and embodiments of the hydraulic paver system described herein.

The method comprises following steps: determining an operation mode selection input, and switching to the respective operation mode of the electric paver depending on the determined operation mode selection input, wherein the operation modes are at least a transporting mode and a paving mode that is different to the transporting mode, and when operating the electric paver in the transporting mode providing a transporting mode actuation signal for activating a first hydraulic circuit and deactivating a second hydraulic circuit, and/or when operating the electric paver in the paving mode providing a paving mode actuation signal for activating the first hydraulic circuit and activating the second hydraulic circuit.

As to the advantages, embodiments and details of the method, reference is made to the corresponding aspect and embodiments of the hydraulic paver system and electric paver described herein above.

According to an embodiment of the method it is provided that when operating the electric paver in the transporting mode or the paving mode controlling a travel speed of the electric paver by controlling the speed of the first electric motor unit and/or if the first hydraulic circuit comprises at least one driving circuit with at least one variable displacement pump, controlling a stroke out of the at least one variable displacement pump.

In a further embodiment of the method it is provided that when operating the electric paver in the paving mode controlling a working speed of at least one working device by controlling the speed of the second electric motor unit and/or depending on the travel speed of the electric paver and, if the second hydraulic circuit comprises at least one working circuit with at least one variable displacement pump, controlling a stroke out of the at least one variable displacement pump, depending on a paving width, a paving height and the paving speed.

According to a further aspect of the present disclosure, the object is achieved by a control unit according to claim 18. The control unit is configured for operating an electric paver as described herein in different operation modes, wherein the control unit is configured to perform the steps of the method as described herein.

As to the advantages, embodiments and details of the control unit, reference is made to the corresponding aspect and embodiments of the hydraulic paver system, the electric paver, and the method described herein above.

According to a further aspect of the present disclosure, the object is achieved by a computer program according to claim 19. The computer program comprising program code means for performing the steps of the method described herein when said program is run on the control unit as described herein.

As to the advantages, embodiments and details of the computer program, reference is made to the corresponding aspect and embodiments of the hydraulic paver system, the electric paver, the method, and the control unit described herein above.

According to a further aspect of the present disclosure, the object is achieved by a computer readable medium according to claim 20. The computer readable medium is configured for carrying a computer program comprising program code means for performing the steps of the method described herein when said program is run on the control unit as described herein.

As to the advantages, embodiments and details of the computer readable medium, reference is made to the corresponding aspect and embodiments of the hydraulic paver system, the electric paver, the method, the control unit, and the computer readable medium described herein above.

Embodiments of the present disclosure are now described below with reference to the drawings. These are not necessarily intended to show the embodiments to scale; rather, where useful for explanation, the drawings are in schematized and/or slightly distorted form.

With regard to additions to the gauges directly recognizable from the drawings, reference is made to the relevant prior art. It should be borne in mind that a wide variety of modifications and changes concerning the shape and detail of an embodiment can be made without departing from the general idea of the present disclosure. The features of the present disclosure described in the description, in the drawings as well as in the claims may be essential for the further development of the disclosed subject matter both individually and in any combination. In addition, all combinations of at least two of the features disclosed in the description, the drawings and/or the claims fall within the scope of the present disclosure. The general idea of the present disclosure is not limited to the exact form or detail of the embodiments shown and described below, or limited to any subject matter that would be limited as compared to the subject matter claimed in the claims. In the case of stated design ranges, values lying within the stated limits are also intended to be disclosed as limiting values and to be capable of being used and claimed as desired. For simplicity, identical reference signs are used below for identical or similar parts or parts with identical or similar function.

Further advantages and advantageous features of the present disclosure are described in the following description and in the dependent claims.

### BRIEF DESCRIPTION OF THE DRAWINGS

With reference to the appended drawings, below follows a more detailed description of embodiments of the present disclosure cited as examples.

In the drawings:

FIG. 1 is a three-dimensional view of a paver in a one embodiment;

FIG. 2 is a schematic circuit diagram of an embodiment of the hydraulic paver system of a paver as shown in FIG. 1;

FIG. 3 is a schematic view of the core components of a further embodiment of the first hydraulic circuit 10; and

FIG. 4 is schematic view of the core components of the second hydraulic circuit as schematically shown in the circuit diagram of the hydraulic paver system in FIG. 2;

FIG. 5 is a schematic block diagram depicting detailed example steps for controlling a hydraulic paver system and, thus, an electric paver in a transporting mode; and

FIG. 6 is a schematic block diagram depicting detailed example steps for controlling a hydraulic paver system and, thus, an electric paver in a paving mode.

### DETAILED DESCRIPTION

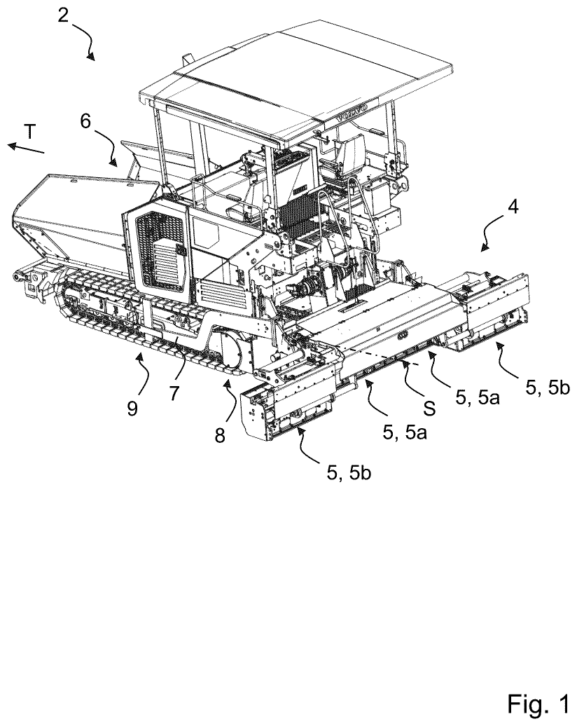

FIG. 1 shows a vehicle 2 in form of an electric paver 2. Although the embodiment of the present disclosure will be described with respect to the paver, the disclosed subject matter is not restricted to this particular heavy-duty vehicle. The disclosed subject matter may also be applied in other heavy-duty vehicles with similar requirements.

As can be seen, the electric paver 2 comprises one screed device 4 having several screed units 5 and a hopper 6.

With respect to the direction of travel T, the screed device 4 is arranged at the back of the electric paver 2 and the hopper 6 is arranged in the front for storing paving material required for paving in operation. For operation, i.e., to produce a road surface, the screed device 4 is arranged behind the paver 2 in the direction of travel T of the electric paver 2 and provided with the paving material stored in the hopper 6. Thus, the screed device 4 virtually follows the paver 2 when a road surface is produced. The screed device 4 is attached to the paver by a screed attachment unit 7. By means of the screed attachment unit 7, the screed device 4 can be lifted up in a transport position when not paving (not shown) or lowered down into a paving position for paving as shown in FIG. 1. Accordingly, the screed attachment unit 7 is usually attached to the electric paver 2 by some kind of lifting device 8, which is configured to lift the screed device 4 up in the transport position or lower it down in the paving position. Further, the screed attachment unit 7 allows to adjust the angle at which the screed device 4 rests on the surface to be produced. To achieve this, the screed attachment unit 7 comprises some kind of angle adjustment device 9, which allows to adjust the angle at which the screed device 4 rests on the surface to be produced.

The two screed units 5 arranged in the middle, directly behind the paver 2, are also known as main screed units 5a. These two main screed units 5a are swivel mounted to the screed attachment unit 7 in such a manner that they can swivel around a swivel axis S that extends in the direction of travel T of the paver 2. This allows adjusting the slope of the road surface. Further, it can be seen that attached to each main screed unit 5a a displaceable screed unit 5b is attached comprising respective extensions to increase the width of the paver 2 for paving.

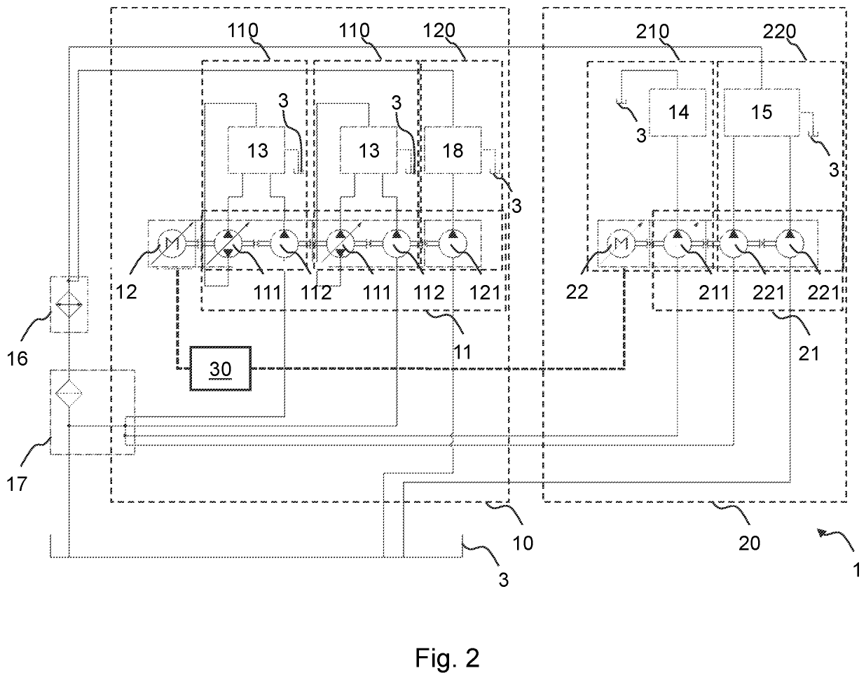

The electric paver 2 disclosed in FIG. 1 may comprise a hydraulic paver system 1 as described in the following with respect to the embodiment of the hydraulic paver system 1 viewed in FIG. 2.

FIG. 2 is a schematic circuit diagram of an embodiment of the hydraulic paver system 1 of a paver 2, for example of the paver 2 as shown in FIG. 1. The hydraulic paver system 1 is configured for operating the electric paver 2 in different operation modes.

The operation modes are at least a transporting mode and a paving mode.

In the transporting mode, the electric paver 2 is driven by means of the hydraulic paver system 1 from a first position to a second position without paving. For example, the hydraulic paver system 1 may be run in the transporting mode to unload the electric paver 2 from a truck and to drive the electric paver 2 to the place of the construction site where the road surface construction is to start. In another example, the hydraulic paver system 1 may be run in the transporting mode in order to drive the electric paver 2 to and on the truck after having finished the road construction. Finally, in a further example, the hydraulic paver system 1 may be run in the transporting mode to drive the electric paver 2 to a parking position or to drive the electric paver 2 from a parking position to the place of the construction site where the road construction is to start. In all of these examples, the paver 2 is driven between different locations without conducting paving operations.

In the paving mode, the electric paver 2 is driven by means of the hydraulic paver system 1 from a first position to a second position whilst paving. Thus, operating the hydraulic paver system 1 in the paving mode means that the electric paver 2 is conducting paving operations whilst being driven. In the paving mode, a road surface is constructed by conducting the paving operations whilst driving the paver 2.

In order to operate the hydraulic paver system 1 and, thus, the electric paver 2 at least in these two operation modes, the hydraulic paver system 1 comprises a first hydraulic circuit and a second hydraulic circuit 20, which can be controlled independently of each other. These two hydraulic circuits 10, 20 are disclosed in FIG. 2.

As can be seen, the first hydraulic circuit 10 comprises a first hydraulic pump arrangement 11 that is configured for providing a hydraulic driving power to at least one driving device 13 for driving the electric paver 2. The first hydraulic pump arrangement 11 is coupled to a first electric motor unit 12. The first electric motor unit is configured for driving the first hydraulic pump arrangement 11 in the transporting mode as well as in the paving mode. Thus, the electric motor provides the hydraulic driving power need for both, when the hydraulic paver system 1 is operated in transporting mode as well when the hydraulic paver system 1 is operated in paving mode.

The second hydraulic circuit 20 comprises a second hydraulic pump arrangement 21. The second hydraulic pump arrangement 21 is configured for providing hydraulic working power for at least one working device of the electric paver 2 for paving. For this purpose, the second hydraulic pump arrangement 21 is coupled to a second electric motor unit 12. The second electric motor unit 12 is configured for driving the second hydraulic pump arrangement 21 in the paving mode for providing the hydraulic working power required when operated in the paving mode.

Depending on the operation mode, the first hydraulic circuit 10 and the second hydraulic circuit 20 of the hydraulic paver system 1 can be activated or deactivated. If the hydraulic paver system 1 is operated in the transporting mode, the first hydraulic circuit 10 is activated and the second hydraulic circuit 20 is deactivated by default. However, if the hydraulic paver system 1 is operated in the paving mode, both hydraulic circuits 10, 20, i.e., the first hydraulic circuit 10 and the second hydraulic circuit 20 are automatically activated by default.

It is to be understood that the deactivated second hydraulic circuit 20 provides a hydraulic standby power that is smaller than the hydraulic working power provided in the paving mode. However, it is particularly preferred, that deactivated means turned off, i.e., in the transporting mode the second hydraulic circuit 20 is turned off automatically by default. In that case, if the second hydraulic circuit 20 is turned off the standby power is equal to zero as the second electric motor unit 12 is turned off and, thus, does not provide any speed and torque that would drive second hydraulic pump arrangement 21.

Accordingly, if the first hydraulic circuit 10 is deactivated, the first hydraulic circuit 10 provides a hydraulic standby power that is smaller than the hydraulic driving power. With respect to the first hydraulic circuit 10 it is particularly preferred, that deactivated means turned off as well, i.e., that the first hydraulic circuit 10 is turned off when deactivated. In that case, if the first hydraulic circuit 10 is turned off the standby power is equal to zero as the first electric motor unit 12 is turned off and, thus, does not provide any speed and torque that would drive first hydraulic pump arrangement 11.

In order to independently control the first hydraulic circuit 10 and the second hydraulic circuit 20, the hydraulic paver system 1 comprises a control unit 30. For this purpose, the control unit 30 is signalling coupled with the first hydraulic circuit 10 and the second hydraulic circuit 20. The control unit 30 is configured for operating the electric paver 2 in the different operation modes depending on an operation mode selection input. The operation mode selection input may usually be provided by the user or driver of the hydraulic paver system 1 and, thus, of the electric paver 2. The user or driver may provide the operation mode selection input via some kind of user interface, for example a touch screen, some kind of button or alike.

If the first hydraulic circuit 10 is activated, the first electric motor unit 12 is driving the first hydraulic pump arrangement 11. On the contrary, if the first hydraulic circuit 10 is deactivated, the first electric motor unit 12 is not driving the first hydraulic pump arrangement 11. In some embodiments, in the deactivated first hydraulic circuit 10 the first electric motor unit 12 is deactivated.

If the second hydraulic circuit 20 is activated, the second electric motor unit 22 is driving the second hydraulic pump arrangement 21. On the contrary, if the second hydraulic circuit is deactivated, the second electric motor unit 22 is not driving the second hydraulic pump arrangement 21. In some embodiments, in the deactivated second hydraulic circuit 20 the second electric motor unit 22 is deactivated.

From the embodiment shown in FIG. 2 of the hydraulic paver system 1, it can be seen that the first hydraulic circuit 10 comprises two driving circuits 110. Each of the driving circuits 110 comprises two pumps, one variable displacement pump 111 and one fixed displacement pump 112. These pumps 111, 112 of the two driving circuits 110 are part of the first hydraulic pump arrangement 11. The variable displacement pump 111 and the fixed displacement pump 112 of each driving circuit 110 are connected in parallel on a driving shaft that is coupled to the first electric motor unit 12.

If the pumps of each driving circuit 110 are driven by the first electric motor unit 12, hydraulic fluid is drawn into the pumps on their input side and supplied to driving devices 13 each driving circuit 110 comprises. Each hydraulic driving device 13 is fluidically connected to the pumps of each driving circuit 110. In particular, each hydraulic driving device 13 is fluidically connected on their input side to the output side of the pumps of each driving circuit 110.

It is to be understood that the variable displacement pump 111 is part of some kind of closed loop hydraulic circuit and the fixed displacement pump 112 is part of some kind of open loop hydraulic circuit. In the closed loop hydraulic circuit a share of the hydraulic fluid that has been used to drive the hydraulic driving device 13 is supplied to the input side of the variable displacement pump 111. The remaining share of the hydraulic fluid that has been used to drive the hydraulic driving device 13 is supplied to the tank unit 3. In the open loop hydraulic circuit, hydraulic fluid is drawn into the stationary displacement pump 112 from the tank unit 3.

Thus, if the first electric motor unit 12 is activated and, thus, driven, the respective pumps that are coupled to the first electric motor unit 12 are driven accordingly depending on the speed and torque provided by the first electric motor unit 12. The driven pumps 111, 112 generate a respective flow of the hydraulic fluid that is used to drive the hydraulic driving device 13. The hydraulic driving device 13 is to be understood as some kind of hydraulic motor that may be coupled to the wheels of the electric paver 2 for driving the electric paver 2. The speed and torque of the hydraulic driving device 13 and of the wheels of the electric paver 2 and, thus, of the electric paver 2 depends on the speed and torque of the first electric motor unit 12 and on the stroke out of the variable displacement pump 111 of the driving circuit 110. It is obvious that the speed of the hydraulic driving device 13 and, thus, of the electric paver 2 may be varied by varying the speed of the first electric motor unit 12 and/or by varying the stroke out of the variable displacement pump 111.

Furthermore, the first hydraulic circuit 10 may comprise one tamper circuit 120 that is at the same time a cooling circuit 120, which is, thus, also called tamper-cooling circuit 120. As can be seen, the tamper-cooling circuit 120 comprises one fixed displacement pump 121. This fixed displacement pump 121 of the tamper-cooling circuit 120 is also part of the first hydraulic pump arrangement 11. The fixed displacement pump 121 of the tamper-cooling circuit 120 is configured for providing a hydraulic tamping power to a tamping actuation device to actuate the tamping device 18 for tamping with the electric paver 2. Additionally, the fixed displacement pump 121 of the tamper-cooling circuit 120 is configured for providing a hydraulic flow to a cooling device 16 for cooling the hydraulic fluid of the first hydraulic circuit 10. The fixed displacement pump 121 of the tamper-cooling circuit 120 is connected in parallel to the remaining pumps of the first hydraulic pump arrangement 11 and also coupled to the first electric motor unit 12.

The speed of the fixed displacement pump 121 of the tamper-cooling circuit 120 is proportional to the speed of the first electric motor unit 12. Thus, the operation of the tamping device 18 is proportional to the speed the first electric motor unit 12.

It is to be understood that in the transporting mode, the tamper device 18 can be deactivated. This may be achieved by controlling a tamper control valve, which prevents a hydraulic flow to or through the tamper actuation device in the transporting mode and, thus, prevents actuation of tamper device 18 when not needed. Thus, it may be controlled that the tamper actuation device is only activated in paving mode for tamping the paving material provided to construct the road surface. In the paving mode, the tamper actuation device is activated automatically by default.

It is to be understood that the fixed displacement pump 121 of the tamper-cooling circuit 120 is providing a flow of hydraulic fluid independent on whether the hydraulic paver system 1 or the electric paver 2 is operated in the transporting mode or the paving mode. The fixed displacement pump 121 of the tamper-cooling circuit 120 needs to run in each operation mode for cooling the hydraulic fluid that is circulated in the first hydraulic circuit 10. Thereby, at least a share of the hydraulic fluid is forwarded to the tank through the cooling device 16 and through a filtering device 17.

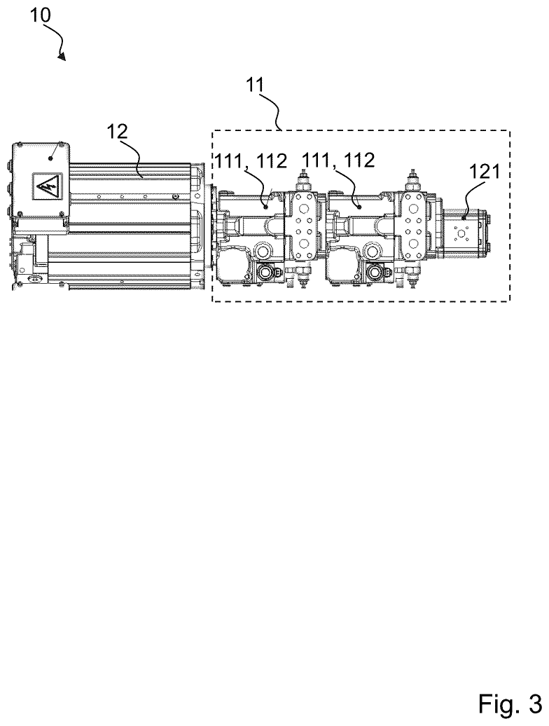

FIG. 3 is a schematic view of the core components of a further embodiment of the first hydraulic circuit 10. Contrary to the embodiment of the first hydraulic circuit 10 shown in FIG. 2, the first hydraulic circuit 10 of the embodiment shown in FIG. 3 comprises just one driving circuit 110. It can be seen that the first hydraulic pump arrangement 11 is directly coupled to the first electric motor unit 12. Further, FIG. 3 illustrates the parallel connection of the variable displacement pump and the fixed displacement pump of the driving circuit 110 and of the fixed displacement pump 121 of the tamper-cooling circuit 120.

In this embodiment of the hydraulic paver system 1 the second hydraulic circuit 20 comprises two hydraulic working circuits 210, 220.

In the paving mode, one of the two hydraulic working circuits 220 generates working power for a working device that is a hydraulic conveyor actuation device 15 for driving at least one conveyor device for conveying paving material along the direction of travel T of the electric paver 2 and a hydraulic auger actuation device 15 for driving an auger device for distributing the paving material crosswise to the direction of travel T of the electric paver 2. Accordingly, this hydraulic working circuit, which incorporates the auger circuit and the conveyor circuit in the same hydraulic circuit 220, is configured for providing hydraulic cylinder power and a hydraulic conveyor power for the hydraulic conveyor actuation device for driving the conveyor device of the electric paver 2 and for the hydraulic auger actuation device 15 for driving the auger device of the electric paver 2.

In the paving mode, the other working hydraulic circuit is a so called cylinder circuit 210 that generates a hydraulic cylinder power as working power for the hydraulic cylinder actuation device 14 for lifting and extending a screed device 4 and its respective screed units 5, 5a, 5b and for opening and for closing the hopper 6.

From FIG. 2 it can be seen that the cylinder circuit 210 comprises one variable displacement pump 211 that is coupled to the second electric motor unit 12. The conveyor circuit and the auger circuit are the same circuit 220 comprising two fixed displacement pumps 221 that are connected in parallel and coupled to the second electric motor unit 12.

Further, the variable displacement pump 211 of the cylinder circuit 210 is connected in parallel with the two fixed displacement pumps 221 of the conveyor and auger circuit 220.

The second hydraulic circuit 20 comprises the hydraulic cylinder actuation device 14 wherein the hydraulic cylinder actuation device 14 is fluidically connected on its input side to the pump 211 of the cylinder circuit 210, so that the pump 211 delivers a hydraulic fluid in the direction of the hydraulic cylinder actuation device 14 during operation for actuating the screed device 4 and hopper 6. The output side of the hydraulic cylinder actuation device 14 is fluidically connected to the tank unit 3.

Further, the second hydraulic circuit 20 comprises the hydraulic auger actuation device and the hydraulic conveyor actuation device 15.

Both, the hydraulic auger actuation device and the hydraulic conveyor actuation device 15 are fluidically connected on its input side to the pumps 221 of the conveyor and auger circuit 220. These pumps 221 then deliver a hydraulic fluid in the direction of the hydraulic auger actuation device and the hydraulic conveyor actuation device 15 during operation to actuate the respective auger device and conveyor device. The output side of the hydraulic auger actuation device and the hydraulic conveyor actuation device 15 is fluidically connected to the tank unit 3, wherein a share of the hydraulic fluid is forwarded to the tank unit 3 through the cooling device 16 and through the filtering device 17.

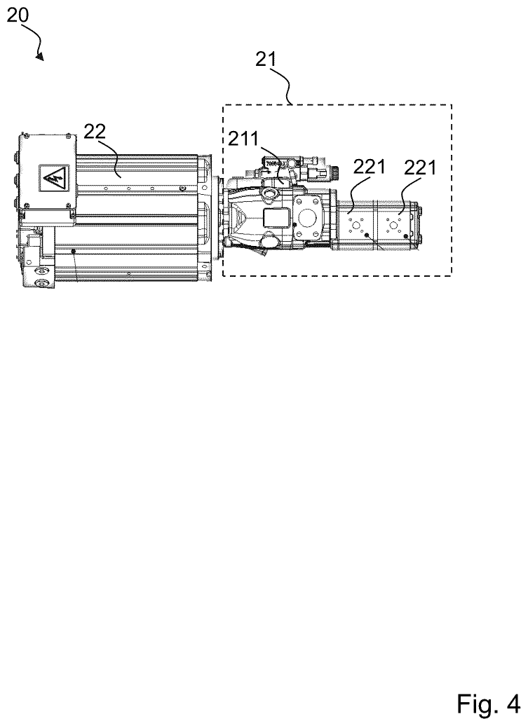

FIG. 4 is a schematic view of the core components of the second hydraulic circuit 20 as schematically shown in the circuit diagram of the hydraulic system 1 in FIG. 2. The schematic arrangement of the second hydraulic circuit 20 shows the parallel connection of the fixed displacement pumps 221 of the conveyor and auger circuit and the variable displacement pump 211 of the cylinder circuit 210 that are part of the second hydraulic pump arrangement 21 and coupled to the second electric motor unit 22.

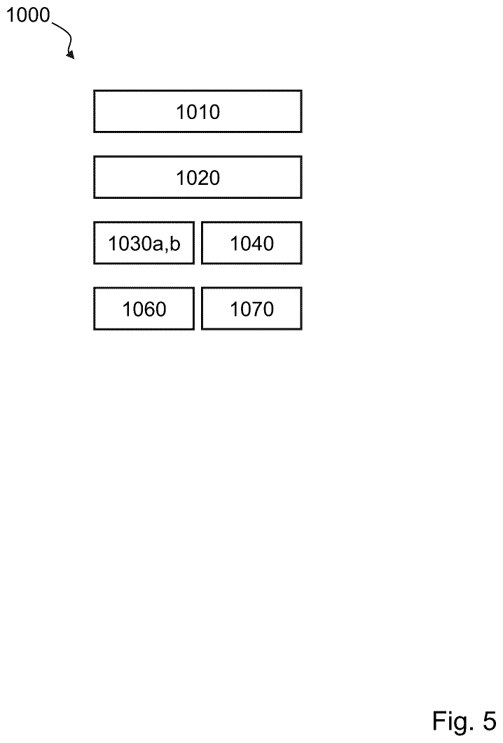

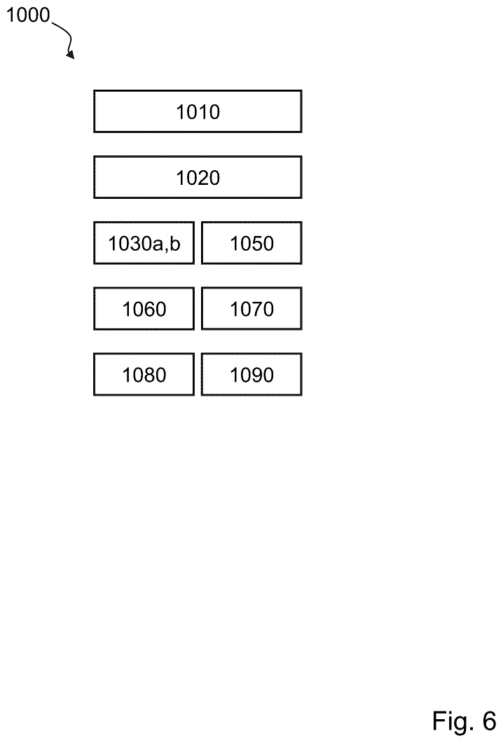

FIGS. 5 and 6 are a schematic block diagrams depicting detailed example steps for operating an electric paver according to some embodiments. FIG. 5 depicts an example embodiment for controlling the electric paver 2 in a transporting mode. FIG. 6 on the other hand depicts an example embodiment for controlling the electric paver 2 in a paving mode.

As disclosed in FIG. 5, the method 1000 for controlling the hydraulic paver system 1 of the electric paver 2 in transporting mode comprises several steps described in the following:

The method includes the step of determining 1010 an operation mode selection input. This may step may be conducted by the user providing information on or selecting the desired operation mode. For example, the user may select on a touch screed or by means of some kind of button or alike the desired operation mode. Based on this selection the operation mode selection input is determined.

Depending on the determined operation mode selection input, i.e., for example, whether paving mode or transporting mode is determined as operation mode, the method comprises the step of switching 1020 to the respective operation mode of the electric paver 2.

When operating the electric paver 2 in the transporting mode is determined, the method comprises the step of providing a transporting mode actuation signal for activating 1030a a first hydraulic circuit 10 and deactivating 1040 a second hydraulic circuit 20. Further, when operating the electric paver 2 in the transporting mode, the travel speed of the electric paver 2 is controlled by controlling 1060 the speed of the first electric motor unit 12 and, by controlling 1070 a stroke out of a variable displacement pump 111 of a driving circuit 110 of the first hydraulic circuit 10. In that regard, a large stroke out leads to a larger flow of the hydraulic fluid and, thus, increases the travel speed further. If on the other hand, the stroke out is minimized, the flow of the hydraulic fluid is minimized and, thus, the travel speed decreased.

As disclosed in FIG. 6, the method 1000 for controlling the hydraulic paver system 1 of the electric paver 2 in paving mode comprises several steps described in the following:

As described with respect to the steps of controlling the electric paver 2 in transporting mode,

The method includes the steps of determining 1010 an operation mode selection input and switching 1020 to the respective operation mode of the electric paver 2 depending on the determined operation mode selection input.

When operating the electric paver 2 in the paving mode is determined, the method comprises the step of providing a paving mode actuation signal for activating 1030b the first hydraulic circuit 10 and activating 1050 the second hydraulic circuit 20. Further, when operating the electric paver 2 in the paving mode, the travel speed of the electric paver 2 is controlled as described above with respect to the control of the travel speed when the electric paver 2 is operated in transporting mode, i.e., by controlling 1060 the speed of the first electric motor unit 12 and by controlling 1070 a stroke out of a variable displacement pump 111 of a driving circuit 110 of the first hydraulic circuit 10.

When operating the electric paver 2 in the paving mode the method further comprises the step of controlling a working speed of at least one working device by controlling 1080 the speed of the second electric motor unit 22. In some embodiments, the speed of the second electric motor unit 22 is controlled depending on the travel speed of the electric paver 2. Further, the if the working circuit comprises a variable displacement pump 211, the working speed may also be controlled depending on the stroke out of the variable displacement pump 211. With respect to the hydraulic paver system 1 described above, the working speed of the hydraulic cylinder actuation device for actuating the screed device 4 and the hopper 6 may be varied, in addition to varying the speed of the second electric motor unit 22, by means of the variable displacement pump 211 that is part of the cylinder circuit 210. Further it is to be understood that the working speed of the second electric motor unit is not only controlled depending on the traveling speed of the electric paver 2 but also depending on a paving width and a paving height of the road surface to be constructed.

### REFERENCE SIGNS

1 hydraulic paver system
2 electric paver
3 tank unit
4 screed device
5, 5a, 5b screed units
6 hopper
7 screed attachment unit
8 lifting device
9 angle adjustment device
10 first hydraulic circuit
11 first hydraulic pump arrangement
12 first electric motor unit
13 hydraulic driving unit
14 hydraulic cylinder actuation device
15 hydraulic auger conveyor actuation device
16 cooling unit
17 filtering device
20 second hydraulic circuit
21 second hydraulic pump arrangement
22 second electric motor unit
110 driving circuit
111, 211 variable displacement pump
112, 121, 221 fixed displacement pump
120 tamper circuit
210 cylinder circuit
220 auger conveyor circuit
S swivel axis
T direction of travel

1. A hydraulic paver system for operating an electric paver in different operation modes,
wherein the operation modes are at least a transporting mode and a paving mode that is different to the transporting mode, and
wherein the hydraulic paver system comprises:
a first hydraulic circuit and a second hydraulic circuit, which can be controlled independently of each other, wherein
the first hydraulic circuit comprises a first hydraulic pump arrangement that is configured for providing a hydraulic driving power to at least one driving device for driving the electric paver, wherein the first hydraulic pump arrangement is coupled to a first electric motor unit, which drives the first hydraulic pump arrangement in a transporting mode and/or in a paving mode for providing the hydraulic driving power, and
the second hydraulic circuit comprises a second hydraulic pump arrangement that is configured for providing hydraulic working power for at least one working device of the electric paver for paving, wherein the second hydraulic pump arrangement is coupled to a second electric motor unit, which drives the second hydraulic pump arrangement in the paving mode for providing the hydraulic working power, and
a control unit that is signalling coupled with the first hydraulic circuit and the second hydraulic circuit, wherein the control unit is configured for operating the electric paver in the different operation modes depending on an operation mode selection input,
wherein in the transporting mode the first hydraulic circuit is activated and the second hydraulic circuit is deactivated, wherein the deactivated second hydraulic circuit provides a hydraulic standby power that is smaller than the hydraulic working power provided in the paving mode.

2. The hydraulic paver system according to claim 1, wherein
in the paving mode the first hydraulic circuit is activated and the second hydraulic circuit is activated, and/or
in the transport mode,
the second hydraulic circuit is turned off, in particular turned off automatically by default, and/or
the second hydraulic circuit may be turned on manually by a user.

3. The hydraulic paver system according to claim 1, wherein
in the activated first hydraulic circuit the first electric motor unit is driving the first hydraulic pump arrangement, and/or
in the deactivated first hydraulic circuit the first electric motor unit is not driving the first hydraulic pump arrangement, wherein in the deactivated first hydraulic circuit the first electric motor unit is deactivated, and/or
in the activated second hydraulic circuit the second electric motor unit is driving the second hydraulic pump arrangement, and/or
in the deactivated second hydraulic circuit the second electric motor unit is not driving the second hydraulic pump arrangement, wherein in the deactivated second hydraulic circuit the second electric motor unit is deactivated.

4. The hydraulic paver system according to claim 1, wherein the first hydraulic circuit comprises at least one driving circuit, wherein the at least one driving circuit comprises at least one pump, in particular at least one variable displacement pump and/or at least one fixed displacement pump, wherein the first hydraulic pump arrangement comprises the at least one pump of the at least one driving circuit.

5. The hydraulic paver system according to claim 4, wherein the at least one driving circuit comprises at least two pumps, in particular the variable displacement pump and the fixed displacement pump, which are connected in parallel.

6. The hydraulic paver system according to claim 5, wherein the first hydraulic circuit comprises at least one tamper circuit and/or at least one cooling circuit, wherein
the at least one tamper circuit comprises a pump that is part of the first hydraulic pump arrangement, wherein the pump of the at least one tamper circuit is configured for providing a hydraulic tamping power to a tamping device for tamping with the electric paver, and/or
the at least one cooling circuit comprises a pump that is part of the first hydraulic pump arrangement, wherein the pump of the at least one cooling circuit is configured for providing a hydraulic flow to a cooling device for cooling the hydraulic fluid of the first hydraulic circuit,
wherein the at least one tamper circuit and the at least one cooling circuit are the same circuit.

7. The hydraulic paver system according claim 4, wherein
the pump or the pumps of the first hydraulic pump arrangement are coupled to the first electric motor unit,
wherein the pumps of the first hydraulic pump arrangement are coupled to the first electric motor unit, are connected in parallel.

8. The hydraulic paver system according to claim 1,
wherein the working devices comprise
at least one hydraulic conveyor actuation device for driving at least one conveyor device for conveying paving material along the direction of travel (T) of the electric paver, wherein the paving material is conveyed in or against the direction of travel (T), and/or
at least one hydraulic auger actuation device for driving at least one auger device for distributing the paving material crosswise to the direction of travel (T) of the electric paver, and/or
at least one hydraulic cylinder actuation device for lifting and/or extending a screed device of the electric paver and/or for opening a hopper and/or for closing the hopper, and/or
at least one hydraulic tamper actuation device for driving at least one tamper device of the electric paver, and/or
wherein the second hydraulic circuit comprises at least one hydraulic working circuit,
wherein the at least one hydraulic working circuit comprises at least one pump, and/or
wherein the at least one hydraulic working circuit is at least one of the following:
at least one conveyor circuit that is configured for providing hydraulic conveyor power for the at least one hydraulic conveyor actuation device for driving the at least one conveyor device of the electric paver,
at least one auger circuit that is configured for providing hydraulic auger power for the at least one hydraulic auger actuation device for driving the at least one auger device of the electric paver,
at least one cylinder circuit that is configured for providing hydraulic cylinder power for the at least one hydraulic cylinder actuation device for lifting and/or extending the screed device of the electric paver and/or for closing the hopper and/or for opening the hopper, and
at least one tamper circuit that is configured for providing hydraulic tamper power for the at least one hydraulic tamper actuation device for driving the tamper device of the electric paver,
at least one vibration circuit that is configured for providing hydraulic vibration power for the at least one hydraulic vibration actuation device for driving the vibration device of the electric paver,
wherein the at least one auger circuit and the at least one conveyor circuit are the same hydraulic circuit.

9. The hydraulic paver system according to claim 1, wherein
the at least one cylinder circuit comprises a pump,
the at least one conveyor circuit comprises a pump, and/or
the at least one auger circuit comprises a pump,
wherein in the case the at least one auger circuit and the at least one conveyor circuit are the same hydraulic circuit, the pumps of the at least one conveyor circuit and the at least one auger circuit are connected in parallel.

10. The hydraulic paver system according to claim 1, wherein
the pump of the at least one cylinder circuit and/or the pump of the at least one auger circuit and/or the pump of the at least one conveyor circuit and/or the pump of the at least one tamper circuit are coupled to the second electric motor unit,
wherein the pumps of the at least one cylinder circuit and/or of the at least one auger circuit and/or the at least one conveyor circuit and/or the pump of the at least one tamper circuit are connected in parallel.

11. The hydraulic paver system according to claim 4, wherein
the first hydraulic circuit comprises at least one hydraulic driving device, wherein each hydraulic driving device is fluidically connected on their input side to the at least one pump of the at least one driving circuit, so that the pump of the respective at least one driving circuit delivers a hydraulic fluid in the direction of the hydraulic driving device during operation of the electric paver,
wherein the output side of each hydraulic driving device is fluidically connected to the input side of the at least one pump of the at least one driving circuit and/or a tank unit.

12. The hydraulic paver system according to claim 6, wherein
the first hydraulic circuit comprises the hydraulic tamper actuation device, wherein the hydraulic tamper actuation device is fluidically connected on its input side to the pump of the respective at least one tamper circuit, so that the pump of the respective at least one tamper circuit delivers a hydraulic fluid in the direction of the hydraulic tamper actuation device during operation of the paver, wherein the output side of each hydraulic tamper actuation device is fluidically connected to the tank unit, wherein a share of the hydraulic fluid is forwarded to the tank through the cooling device and/or through a filtering device.

13. The hydraulic paver system according to claim 1, wherein
the second hydraulic circuit comprises the hydraulic cylinder actuation device, wherein the hydraulic cylinder actuation device is fluidically connected on its input side to the pump of the respective at least one cylinder circuit, so that the pump delivers a hydraulic fluid in the direction of the hydraulic cylinder actuation device during operation, wherein the output side of each hydraulic cylinder actuation device is fluidically connected to the tank unit, and/or
the second hydraulic circuit comprises the hydraulic auger actuation device, wherein the hydraulic auger actuation device is fluidically connected on its input side to the pump of the respective at least one auger circuit, so that the pumps delivers a hydraulic fluid in the direction of the hydraulic auger actuation device during operation, wherein the output side of each hydraulic auger actuation device is fluidically connected to the tank unit, wherein a share of the hydraulic fluid is forwarded to the tank unit through the cooling device and/or through the filtering device, and/or
the second hydraulic circuit comprises the hydraulic conveyor actuation device, wherein the hydraulic conveyor actuation device is fluidically connected on its input side to the pump of the respective at least one conveyor circuit, so that the pumps delivers a hydraulic fluid in the direction of the hydraulic conveyor actuation device during operation, wherein the output side of each hydraulic conveyor actuation device is fluidically connected to the tank unit, wherein a share of the hydraulic fluid is forwarded to the tank unit through the cooling device and/or through the filtering device.

14. An electric paver for constructing a road surface, said paver comprising a hydraulic paver system according to claim 1.

15. A method for operating an electric paver according to claim 14 in different operation modes, the method comprising following steps:
determining an operation mode selection input, and
switching to the respective operation mode of the electric paver depending on the determined operation mode selection input, wherein the operation modes are at least a transporting mode and a paving mode that is different to the transporting mode, and
when operating the electric paver in the transporting mode
providing a transporting mode actuation signal for activating a first hydraulic circuit and deactivating a second hydraulic circuit, and/or
when operating the electric paver in the paving mode
providing a paving mode actuation signal for activating the first hydraulic circuit and activating the second hydraulic circuit.

16. A method according to claim 15,
when operating the electric paver in the transporting mode or the paving mode controlling a travel speed of the electric paver by controlling the speed of the first electric motor unit and/or if the first hydraulic circuit comprises at least one driving circuit with at least one variable displacement pump, controlling a stroke out of the at least one variable displacement pump.

17. A method according to claim 15,
when operating the electric paver in the paving mode controlling a working speed of at least one working device by controlling the speed of the second electric motor unit and/or depending on the travel speed of the electric paver and, if the second hydraulic circuit comprises at least one working circuit with at least one variable displacement pump, controlling a stroke out of the at least one variable displacement pump, depending on a paving width, a paving height and the paving speed.

18. A control unit for operating an electric paver in different operation modes, wherein the control unit is configured to perform the steps of the method according to claim 15.

19. A computer program comprising program code means for performing the steps of claim 15 when said program is run on a control unit.

20. A computer readable medium carrying a computer program comprising program code means for performing the steps of claim 15 when said program is run on a control unit.
